(19) United States
(12) Patent Application Publication
(10) Pub. No.: US 2026/0136339 A1
(43) Pub. Date: May 14, 2026

(54) OVERLAPPING FREQUENCY BAND RADIO MANAGEMENT

(71) Applicant: DISH Wireless L.L.C., Littleton, CO (US)

(72) Inventor: Montgomery N. Groff, Denver, CO (US)

(21) Appl. No.: 18/946,409

(22) Filed: Nov. 13, 2024

(51) Int. Cl. H04W 72/0453; H04W 52/36

(52) U.S. Cl. CPC H04W 72/0453; H04W 52/367

(57) ABSTRACT

Various arrangements are presented for effectively using overlapping frequency bands. A cellular network can receive priority data indicative that for a defined geographic region the cellular network is a highest priority user. The cellular network can determine, based on the priority data, to use a portion of the citizen band radio service (CBRS) for communication with pieces of user equipments (UEs) within the defined geographic region. The cellular network can then determine to use a portion of a frequency band distinct from the CBRS for communication with the UEs. In response, the cellular network can cause a single frequency band definition to be activated by the UEs that authorizes use of the portion of the CBRS and the portion of the frequency band distinct from the CBRS.

### BACKGROUND

Cellular network communications can occur via various frequency bands depending on the cellular network, geographic location, and other factors. A cellular network carrier that operates a cellular network can bid at an auction to acquire the rights to various frequency blocks to be used for wireless communication for a particular jurisdiction. In the location where a particular frequency block is acquired, the cellular network carrier can use the frequency block for communication between user equipment (UEs) and the cellular network’s base stations (BSs) within the power constraints set for the frequency block. The UEs are provided with instructions from the cellular network’s base stations indicating the frequency blocks upon which communication is authorized.

### SUMMARY

In some embodiments, a method for using overlapping frequency bands is presented. The method can include receiving, by a cellular network, priority data indicative that for a defined geographic region the cellular network is a highest priority user. The method can include determining, by the cellular network, based on the priority data, to use a first portion of the citizen band radio service (CBRS) for communication with a plurality of user equipments (UEs) within the defined geographic region. The method can include determining, by the cellular network, to use a second portion of a frequency band distinct from the CBRS for communication with the plurality of UEs. The method can include, in response to (1) determining to use the first portion of the CBRS based on the priority data and (2) determining to use the second portion of the frequency band distinct from the CBRS, transmitting, by the cellular network, a message activating a single frequency band definition at the plurality of UEs. The message can cause use of the first portion of the CBRS and the second portion of the frequency band distinct from the CBRS.

Embodiments of such a method can include one or more of the following features: The method can include communicating, by a base station (BS) of the cellular network, with a UE of the plurality of UEs using the first portion of the CBRS and the second portion of the frequency band distinct from the CBRS. Communication with the UE may be performed using a first maximum power level for the first portion of the CBRS and a second maximum power level for the second portion of the frequency band distinct from the CBRS, wherein the second maximum power level is greater than the first maximum power level. The cellular network can be a 5G New Radio (NR) cellular network and communicating by the BS with the UE is performed via a 5G NR cellular communication protocol. The single frequency band definition may indicate only the n78 frequency band. The first portion of the CBRS and the second portion of the frequency band distinct from the CBRS may define immediately adjacent frequency blocks. The method can include activating, by each UE of the plurality of UEs, use of the single frequency band for communication with the cellular network. The single frequency band definition can be transmitted as part of radio resource control (RRC) signaling from a central unit (CU) of the cellular network to the plurality of UEs. The defined geographic region may be a county. The method can include receiving, by the cellular network, a second set of priority data indicative that for the defined geographic region the cellular network is not the highest priority user. The method can include determining, by the cellular network, based on the priority data, to cease using the first portion of the CBRS for communication with the plurality of UEs within the defined geographic region. The method can include, in response to determining to cease using the first portion of the CBRS based on the priority data, transmitting a modified single frequency band definition to the plurality of UEs that deauthorizes use of the first portion of the CBRS and authorizes the second portion of the frequency band distinct from the CBRS.

In some embodiments, a system for using overlapping frequency bands is presented. The system can include a cellular network that is in communication with a sensor network. The cellular network can include multiple base stations and a cellular network core. The cellular network may receive priority data indicative that for a defined geographic region the cellular network is a highest priority user. The cellular network may determine, based on the priority data, to use a first portion of the citizen band radio service (CBRS) for communication with a plurality of user equipments (UEs) within the defined geographic region. The cellular network may determine, to use a second portion of a frequency band distinct from the CBRS for communication with the plurality of UEs. The cellular network may, in response to (1) determining to use the first portion of the CBRS based on the priority data and (2) determining to use the second portion of the frequency band distinct from the CBRS, transmit a message activating a single frequency band definition at the plurality of UEs. The message may cause use of the first portion of the CBRS and the second portion of the frequency band distinct from the CBRS.

Embodiments of such a system can include one or more of the following features: The cellular network may be further configured to communicate, via a base station of the plurality of base stations, with a UE of the plurality of UEs using the first portion of the CBRS and the second portion of the frequency band distinct from the CBRS. Communication with the UE may be performed by the cellular network using a first maximum power level for the first portion of the CBRS and a second maximum power level for the second portion of the frequency band distinct from the CBRS, wherein the second maximum power level is greater than the first maximum power level. The cellular network may be a 5G New Radio (NR) cellular network and wireless communication with the UE is performed via a 5G NR cellular communication protocol. The single frequency band definition may indicate only the n78 frequency band. The first portion of the CBRS and the second portion of the frequency band distinct from the CBRS may define adjacent frequency blocks. The system can include the plurality of UEs, wherein each UE is configured to activate use of the single frequency band for communication with the cellular network. Activation of the single frequency band definition may be transmitted as part of radio resource control (RRC) signaling from a central unit (CU) of the cellular network to the plurality of UEs. The cellular network may be configured to receive a second set of priority data indicative that for the defined geographic region the cellular network is not the highest priority user. The cellular network may be configured to determine, based on the priority data, to cease using the first portion of the CBRS for communication with the plurality of UEs within the defined geographic region. The cellular network may be configured to, in response to determining to cease using the first portion of the CBRS based on the priority data, transmit a second message indicative of a modified single frequency band definition to the plurality of UEs that deauthorizes use of the first portion of the CBRS.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a cellular network integrated with a frequency band usage sensing network.

FIG. 2 illustrates an embodiment of tiered access to a frequency band.

FIG. 3 illustrates an embodiment of overlapping frequency band definitions.

FIG. 4 illustrates an embodiment of a method for efficiently using overlapping frequency bands.

FIG. 5 illustrates an embodiment of a method for reverting to use of a single frequency band.

### DETAILED DESCRIPTION

When multiple frequency bands are in use by a piece of user equipment (UE), power consumption by the UE can increase. For example, when frequency blocks (e.g., of 10 MHz) across two (or more) frequency bands are being used for communication with a cellular network, communication on each frequency band may be at least partially managed separately. The frequencies to which any given cellular carrier has access can be varied and dependent on the licenses the carrier has acquired from the government that governs a particular geographic region. For example, the United States government operates spectrum auctions which any cellular network carrier can bid in to attempt to obtain spectrum for use. Such auctions can result in one cellular network carrier acquiring the rights to a particular frequency block in one jurisdiction while another cellular network carrier (or another type of entity altogether) acquires the rights to the same particular frequency block in another jurisdiction.

In arrangements detailed herein, embodiments are detailed in which a first frequency band is activated for communications with UEs. This first frequency band spans sufficient bandwidth that it overlaps additional frequencies that can be defined within a second frequency band. Rather than activating the second frequency band with the UEs, only the first frequency band is activated at the UEs and the UEs are instructed to use the additional frequencies as part of the first frequency band. Power management can be performed at the BSs such that the power limitations of both bands are conformed to despite the frequency blocks being spread across multiple frequency bands.

In some embodiments detailed herein, a cellular network carrier has acquired the rights to use one or more frequency blocks of the citizen band radio service (CBRS) when not in use by one or more higher-priority users. The cellular network carrier also has the rights to use one or more frequency blocks within n77, n78, or both. Rather than activating CBRS (i.e., n48) for communication at UEs, n77 and/or n78 is activated. Via radio resource control (RRC) signaling, the central unit (CU) of a gNodeB (gNB) defines the carrier aggregation configuration to include n77 or n78 (and specifically does not authorize n48). As part of the RRC signaling, frequency blocks within CBRS are authorized by the gNB for use for wireless communication by the UEs.

Such an arrangement allows for the UEs to make more efficient use of frequency blocks across multiple frequency bands. By configuring a UE to use a number of frequency blocks within one frequency band as opposed to the same number of frequency blocks across multiple frequency bands reduces the power and processing overhead at the UE. The same uplink and downlink bandwidth can be realized, but with reduced power and processing consumption.

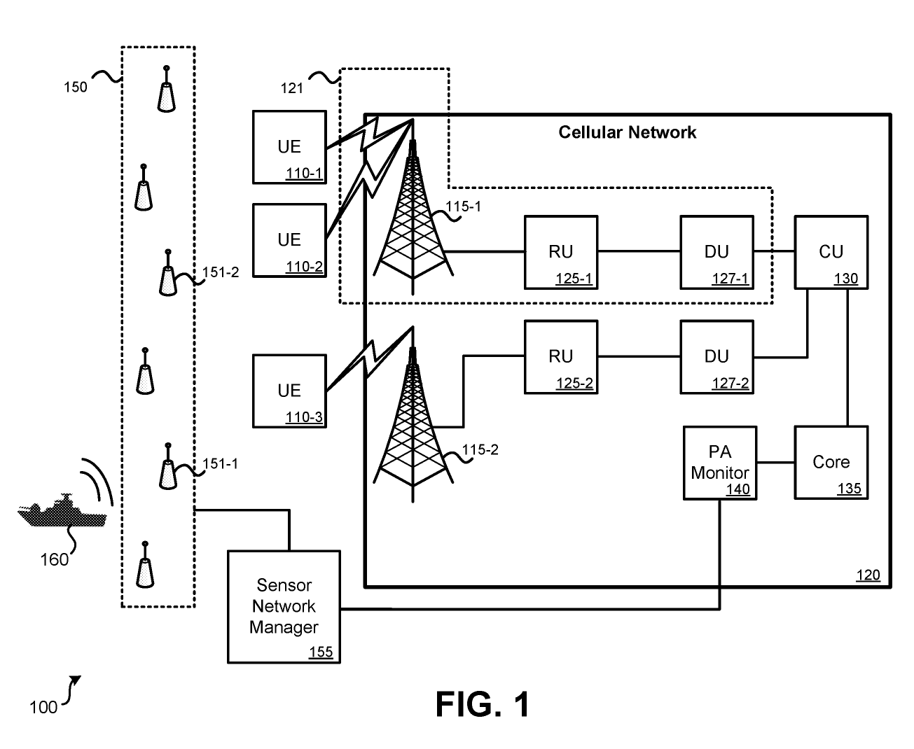

Further detail is provided in relation to the figures. FIG. 1 illustrates an embodiment of a cellular network system (system “100”) that includes a cellular network integrated with a frequency band usage sensing network. System 100 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible in alternate embodiments. System 100 can include: UE 110 (UE 110-1, UE 110-2, UE 110-3); base stations 115 (BS 115-1, BS 115-2); cellular network 120; radio units 125 (“RUs 125”); distributed units 127 (“DUs 127”); central unit 129 (“CU 129”); core 139, and orchestrator 138. FIG. 1 represents a component level view. In a virtualized open radio access network (O-RAN), because components can be implemented as software in the cloud, except for components that receive and transmit RF, the functionality of various components can be shifted among general-purpose computing systems, for which the hardware may be maintained by a separate (e.g., public) cloud-computing system, to accommodate where the functionality of such components is needed. As an example, network functions (NFs) within core 135 can be hosted using a cloud-computing system.

UEs 110 can represent various types of end-user devices, such as smartphones, cellular modems, cellular-enabled computerized devices, sensor devices, manufacturing equipment, gaming devices, access points (APs), or any computerized device capable of communicating via a cellular network, etc. UEs can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UEs 110 may use RF across various frequency bands to communicate with various base stations of cellular network 120. Two BSs 115 (BS 115-1, 115-2) are illustrated. Real-world implementations of system 100 can include many (e.g., hundreds, thousands) base stations, and many RUs, DUs, and CUs. BS 115 can include one or more antennas that allow RUs 125 to communicate wirelessly with UEs 110. RUs 125 can represent an edge of cellular network 120 where data is transitioned to wireless communication. In some implementations, the radio access technology (RAT) used by RU 125 is 5G New Radio (NR). Other implementations use other RAT, such as 4G Long Term Evolution (LTE). The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. A primary function of a DU can be scheduling RF communications with UEs 110. Different RUs may be present for different portions of the spectrum. For instance, a first RU may operate on the spectrum in the citizens broadcast radio service (CBRS) band while a second RU may operate on a separate portion of the spectrum, such as, for example, “n71” (an RF band near 600 Megahertz allocated for cellular communications). One or more DUs, such as DU 127-1, may communicate with CU 129. Collectively, one or more RUs, one or more DUs, and a CU create a gNodeB in a 5G NR cellular network. Therefore, a gNB can refer which serves as the radio access network (RAN) of cellular network 120. CU 129 can communicate with core 139. The specific architecture of cellular network 120 can vary by embodiment. Edge cloud server systems outside of cellular network 120 may communicate, either directly, via the Internet, or via some other network, with components of cellular network 120. For example, one or more DUs 127-1 may be able to communicate with an edge cloud server system (not illustrated) without routing data through CU 130 or core 135.

At a high level, the various components of a gNB can be understood as follows: RUs perform RF-based communication with UE; DUs support lower layers of the protocol stack such as the radio link control (RLC) layer, the medium access control (MAC) layer, and the physical communication layer; and CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can manage communications for multiple RUs.

For some frequency bands, the cellular network carrier operating cellular network 120 may not have sole access. Rather, a tiered priority arrangement may be present where cellular network 120 is only permitted to use frequency blocks within the frequency band to which the cellular carrier has acquired a license when the frequency blocks are unused by a higher-tier user. In order to determine whether a higher-tier user is currently using the frequency block, a spectrum access system (SAS) can be used to determine for various geographic areas whether frequencies are in use by a higher tier user.

Sensor network 150 may be geographically distributed as part of a SAS to determine the entity currently using particular frequency bands or frequency blocks. One or more of sensors 151 can be present in a geographic area, such as within a particular county (e.g., a county of a state within the United States), to determine if, for that county, a particular user is using the frequency band or block. Sensor network manager 155, which can be operated by the carrier of cellular network 120 or by one or more separate third parties, can aggregate data from sensor network 150 and provide information indicative of whether particular frequency blocks or bands are available for use for given geographic regions (e.g., per county, per city, per state, per any other defined geographic areas).

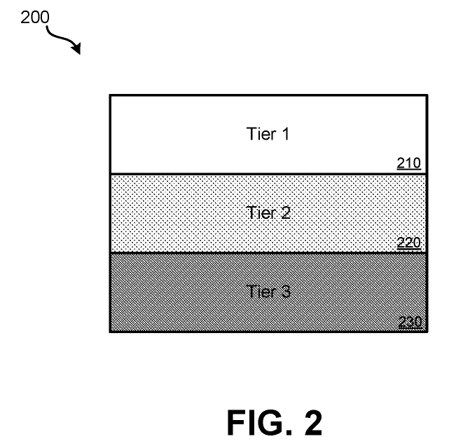

As an example, a higher-priority user, such as ship 160 that is part of the US Navy, may be in or nearby the geographic region in which sensor 151-1 is present. Ship 160 may actively be using an L-band radar that overlaps with frequencies with CBRS. Lower-tier users, as detailed in relation to FIG. 2, may be required, if presently using, to terminate use of some CBRS frequency blocks or all of the CBRS band in response in the same geographic area. Lower-tier users may be permitted to continue using the same frequency blocks in other geographic areas, such as associated with sensor 151-2 where no use by a higher-priority entity is detected. Sensor network manager 155 can sense the use of CBRS frequencies by ship 160 and provide information that cellular network 120 can use to determine whether it must cease use of some CBRS frequency blocks or all of the CBRS band in response. Sensor network manager 155 may actively push such information to cellular network 120 or a component of cellular network 120 may periodically or occasionally poll sensor network manager 155 to determine whether use of the CBRS or particular frequency blocks within CBRS is permissible. Cellular network 120 may have a component, such as priority access (PA) monitor 140, operated on a cloud-based computing system or computing system directly incorporated as part of cellular network 120. PA monitor 140 can be in communication with core 135 or directly in communication with the CUs, including CU 130, or cellular network 120. PA monitor 140 may inform CUs whether use of frequency blocks or bands with CBRS is permissible. The CUs use RRC signaling with UEs, via DUs 127 and RUs 125 to configure UEs to communicate using the appropriate frequency blocks and bands.

The above examples make reference to CBRS and the rules established by the US government regarding priority access by various tiered users to the frequency band, however this is just an example. Various jurisdictions can have regulations affecting these and various other frequency bands. For example, for some frequencies, a particular entity (user) may have exclusive right to a particular frequency band or block. Further detail regarding the tiered arrangement of CBRS is provided in relation to FIG. 2.

FIG. 2 illustrates an embodiment 200 of tiered access to a frequency block within a frequency band. For example, a three-tier arrangement can be used in the United States to manage access to CBRS. CBRS extends from 3.55 GHz to 3.7 GHz. Lower priority tier users are only permitted to use frequency blocks in CBRS when higher-tier priority users are not presenting using the same frequency blocks. Such frequency blocks can be 10 MHz wide (e.g., a frequency block from 3550 – 3560 MHz, another frequency block from 3560 MHz – 3570 MHz, etc.).

Tier one 210, which represents the highest tier of priority-users in CBRS, can represent various incumbent users, such as the military, which may operate L-band radar using frequencies within CBRS. Additionally, or alternatively, various wireless internet service providers (WISPS) and flight service stations (FSSs) may have grandfathered rights to use of CBRS in Tier One 210. If a tier two 220 or tier three 230 user is using a CBRS frequency block and a tier one 210 user, such as a WISP begins using the frequency block, the tier two 220 and tier three 230 users must cease use immediately.

Tier two 220 can represent priority access license (PAL) users. An entity, such as a carrier operating cellular network 120, may accurate a license to various frequency blocks within CBRS in various geographic locations (e.g., per county) from the relevant jurisdiction (e.g., the US federal government). Use of a frequency block acquired in tier two 220 is contingent on a tier one 210 user not presently using the same frequency block. Therefore, monitoring, such as via sensor network 150 is required to determine if any tier one 210 entity is operating in the frequency block in a particular geographic area.

Tier three 230 can represent a general authorized access band that is unlicensed. This band can be used by any party, assuming that no tier one 210 or authorized tier two 220 entity is presently operating in the frequency block, as determined using sensor network 150, in a particular geographic area, users in tier three 230 can use frequency blocks within CBRS.

While a three-tier system is shown for CBRS, this is by way of example only. In other embodiments, fewer or greater numbers of tiers may be present. Alternatively, a frequency band other than CBRS can have a tiered access arrangement in which one or more entities have use priority over other entities.

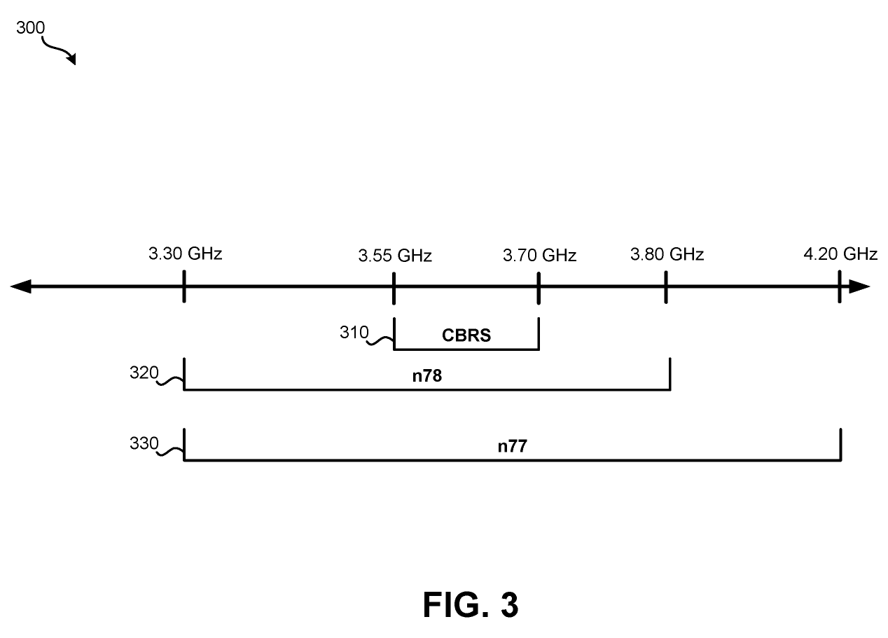

FIG. 3 illustrates an embodiment 300 of overlapping frequency band definitions. In embodiment 300, three frequency band definitions are shown: CBRS (n48) 310 which spans from 3.55 GHz to 3.70 GHz; (n78) 302, which spans 3.30 GHz to 3.80 GHz; and (n77) 330, which spans from 3.30 GHz to 4.20 GHz.

A cellular carrier, such as the carrier operating cellular network 120, may have acquired the rights to use frequency blocks within n78, n77, and/or n48. While, for example, the rights to a frequency block (e.g., a 10 MHz frequency block) within n78 between 3.30-3.55 GHz may grant the carrier exclusive or highest-priority rights, the rights to one or more frequency blocks (e.g., 10 MHz frequency blocks) within CBRS 310 may be a lower tier (e.g., tier two) and thus require that use be ceded to higher-priority incumber users having tier one priority.

As an example, a cellular carrier may have the right to 3.50 GHz to 3.55 GHz in n78 and 3.55 GHz to 3.60 GHz in CBRS 310. Put more generally, the cellular carrier can have the rights to two adjacent frequency blocks (or non-adjacent frequency blocks in overlapping frequency bands) that are governed by different rules. Due to the differences in priority, these frequency blocks need to be managed differently. Further, the amount of power available for transmission on each of these frequency blocks can vary based on regulation. For example, in CBRS, depending on the situation, a maximum power of 47, 30, or 23 dBm may be used for transmission. While outside of CBRS 310, 72 (urban) or 75 (rural) dBm may be used for transmission in n78. Additionally, or alternatively, the cellular carrier can have rights to non-adjacent frequency blocks in CBRS, n77, and/or n78.

As detailed above, the rules governing CBRS 310 differs from the rules governing n78 320 and n77 330; however, the frequencies of CBRS 310 falls wholly within n78 320 and n77 330. From the perspective of UEs, if configured properly, communications within CBRS 310 can be treated the same as communications within n78 320 or n77 330. That is, management of the specific requirements of CBRS 310 can be managed by cellular network 120; a UE itself, may only configured for communication on n78 320 or n77 330 without specific configuration for CBRS 310.

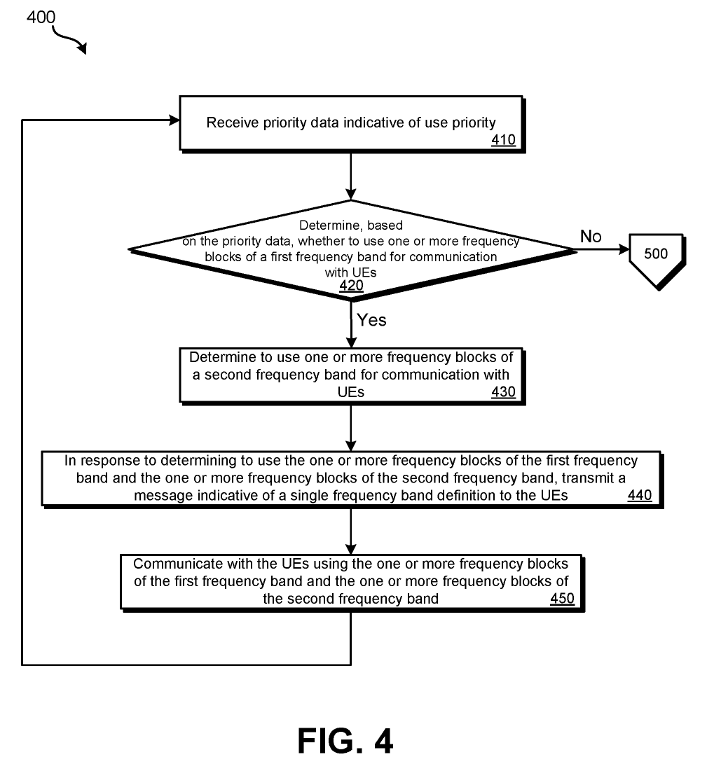

Various methods can be performed using the arrangements detailed in relation to FIGS. 1-3. FIG. 4 illustrates an embodiment of a method 400 for efficiently using overlapping frequency bands. Method 400 can be performed using system 100. Specifically, each block of method 400 can be performed using cellular network 120.

At block 410, priority data indicative of use priority of one or more frequency blocks or a frequency band is received. Block 410 can involve a priority access monitor component of the cellular network receiving such priority data from a sensor network. The priority access monitor can send a permission or denial to use a particular frequency block or band to one or more CUs that manage radio relay control signaling for one or more base stations or gNBs. The sensor network can be operated as part of the cellular network or by a separate entity that provides such data to other parties (e.g., for a fee). Referring to FIG. 1, in system 100, sensor network manager 155 may be in communication with many sensors that monitor the use of a frequency band or frequency blocks for use of priority users. In some arrangements, the cellular network used to perform method 400 can be a tier two user and, thus, needs to not use particular frequency blocks or a frequency band when a tier one user is actively using in the same geographic region (e.g., on a county-by-county basis).

In some embodiments, block 410 includes making sensor measurements to detect whether or not one or more frequency blocks or a frequency band is in use and determining a priority of such use. For example, referring to CBRS, for a tier two user, use by a tier three user can be ignored since the tier three user is required to cease use when the tier two user begins asserting its rights. In other embodiments, if the cellular carrier has top priority or exclusive rights to a frequency block, no priority data may need to be obtained.

At block 420, based on the priority data received at block 410, the cellular network can determine whether to use a portion of a frequency band (e.g., one or more frequency blocks) of a first frequency band for communication with UEs. If the frequency block or bands is not being used by a higher tier user, method 400 can proceed to block 430. If the frequency block or bands is being used by a higher tier user, method 400 can proceed to method 500, such as if such frequency blocks or band is currently in use by the cellular network.

At block 430, the cellular network may also determine to use a portion of a second frequency band for communication with UEs in the same geographic region as the use determined for the frequency band of block 420. The frequency band of block 420 partially or fully overlaps the frequency band of block 430. For example, referring to FIG. 3, the first frequency band can be CBRS and the second frequency band can be n78 or n77. That is, all frequency blocks within CBRS are within n78 and n77. In some embodiments, rather than an active determination being made at block 430, use of the second frequency band may already be occurring by the cellular network. For example, the cellular network may have exclusive or highest priority rights to one or more frequency blocks within the second frequency band and may continuously or near continuously use such frequency blocks without needing to make a determination as to whether to use such frequencies.

At block 440, in response to the determinations of blocks 420 and 430, a message indicative of a single frequency band to be activated at one or more UEs as part of the carrier aggregation is transmitted. Block 440 can be performed using transmission of a master information block (MIB) by the gNB and/or RRC signaling between the gNB (or, more specifically, by the CU) and the UEs. A PCell (primary cell) and one or more secondary cells (SCells) can be defined as part of the carrier aggregation. The PCell can be used to initiate access by the UE via random access (RACH). Via the signaling, a single frequency band is activated (e.g., only the second frequency band), which includes the frequency blocks of the first frequency band that are also to be used for communication with the UEs. In some embodiments, the second frequency band that is activated for communication is n77 or n78 and the first frequency band that is not explicitly activated but has frequency blocks falling within the n77 or n78 bands is CBRS. Following block 440, at each of the UEs, one frequency band is enabled for use instead of two frequency bands, the first of which being wholly or partly within the second frequency band.

In some embodiments, at the cellular network, different power levels for transmission can be set for frequency blocks within the first frequency band and frequency blocks within the second frequency band that fall outside of the first frequency band. Referring to CBRS, a lower transmit power level, such as 30 or 47 dBm may be permissible while a higher transmit power level, such as 72 or 75 dBm may be permissible for n77 or n78 outside of CBRS. Additionally, or alternatively, for frequency blocks falling within the first frequency band (e.g., CBRS), signaling with UEs may be used to set a maximum transmit power of the UEs within CBRS to a lower limit, such as 23 dBm (for a 10 MHz frequency block).

At block 450, cellular communication between one or more of the UEs and the cellular network can be performed using frequency blocks within the portions of the first frequency band and the second frequency band. Such cellular communication can be for any form of data transfer, such as phone calls, texting, network access, etc. From the perspective of the UE, only the single enabled frequency band is being used; from the perspective of the cellular network, two distinct frequency bands are being used, each with their own requirements (e.g., priority and transmit power levels).

As an example, a cellular carrier may have rights to 3.50 GHz to 3.55 GHz in n78 and 3.55 GHz to 3.60 GHz in CBRS (possibly in only particular counties) in the United States. When a higher tier user is not using the CBRS frequency blocks, which can be 10 MHz blocks, falling within 3.55 GHz to 3.60 GHz, the cellular carrier can enable a single frequency band n78 at UEs and assign frequency blocks within the CBRS frequency blocks. The cellular network can ensure that all transmit power requirements are met that meet the requirements of CBRS and ensure that no higher tier user is attempting to use the frequencies.

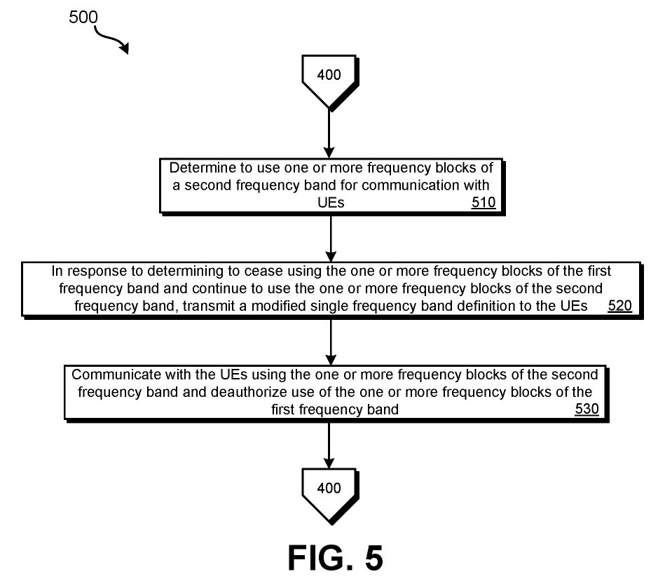

Following block 450, if a higher-priority user exists, method 400 can continue to monitor priority data to determine if a higher priority user is attempting to use one or more frequency blocks of the first frequency band. If not, no changes may need to be made; however, when a higher-tier user asserts its rights, method 400 can proceed to method 500 of FIG. 5.

FIG. 5 illustrates an embodiment of a method 500 for reverting to use of a single frequency band. Method 500 can be performed using system 100. Specifically, each block of method 500 can be performed using cellular network 120. Method 500 can be performed when a higher tier priority user has asserted its rights to use one or more frequency blocks currently being used by the cellular network for communication with UEs. For example, in CBRS in the US, the defense department may have activated a radar that uses CBRS frequencies.

At block 510, a determination is made to use a portion of the second frequency band for communication with UEs, but not one or more frequency blocks of the first frequency band. For example, the first frequency band can be CBRS in which a higher-priority user is asserting its right to use the frequency blocks; the second frequency band may be n77 or n78 frequency blocks that fall outside of the CBRS frequency band. Therefore, at block 510, the n77 or n78 frequencies outside of CBRS remain available for use by the cellular network carrier, but not one or more frequency blocks within CBRS in a particular geographic area.

At block 520, in response to determining to not use (or cease) using one or more frequency blocks within the first frequency band based on the determinations of blocks 510 and 420 (of FIG. 4), a modified single frequency band definition is transmitted to the UEs. This modified single frequency band definition continues to indicate the second frequency band, but no longer authorizes use of the frequency blocks of the first frequency band to which the cellular network currently does not have priority. As an example, the definition of block 520 may continue to specify n77 or n78, but no longer authorizes use of one or more frequency blocks falling within CBRS.

At block 530, cellular communication between one or more of the UEs and the cellular network can be performed using frequency blocks within the authorized portions of the second frequency band while excluding the frequency blocks of the first frequency band currently prohibited. Such cellular communication can be for any form of data transfer, such as phone calls, texting, network access, etc. From the perspective of the UE, only the single enabled frequency band remains being used. Following block 530, method 500 may return to block 410 to continue to monitor for when one or more frequency blocks of the first frequency band ceases to be used by a higher priority user so that the cellular network can resume using.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for using overlapping frequency bands, the method comprising:
receiving, by a cellular network, priority data indicative that for a defined geographic region the cellular network is a highest priority user;
determining, by the cellular network, based on the priority data, to use a first portion of the citizen band radio service (CBRS) for communication with a plurality of user equipments (UEs) within the defined geographic region;
determining, by the cellular network, to use a second portion of a frequency band distinct from the CBRS for communication with the plurality of UEs; and
in response to (1) determining to use the first portion of the CBRS based on the priority data and (2) determining to use the second portion of the frequency band distinct from the CBRS, transmitting, by the cellular network, a message activating a single frequency band definition at the plurality of UEs, wherein the message causes use of the first portion of the CBRS and the second portion of the frequency band distinct from the CBRS.

2. The method for using overlapping frequency bands of claim 1, further comprising:
communicating, by a base station (BS) of the cellular network, with a UE of the plurality of UEs using the first portion of the CBRS and the second portion of the frequency band distinct from the CBRS.

3. The method for using overlapping frequency bands of claim 2, wherein communication with the UE is performed using a first maximum power level for the first portion of the CBRS and a second maximum power level for the second portion of the frequency band distinct from the CBRS, wherein the second maximum power level is greater than the first maximum power level.

4. The method for using overlapping frequency bands of claim 3, wherein the cellular network is a 5G New Radio (NR) cellular network and communicating by the BS with the UE is performed via a 5G NR cellular communication protocol.

5. The method for using overlapping frequency bands of claim 1, wherein the single frequency band definition indicates only the n78 frequency band.

6. The method for using overlapping frequency bands of claim 1, wherein the first portion of the CBRS and the second portion of the frequency band distinct from the CBRS define immediately adjacent frequency blocks.

7. The method for using overlapping frequency bands of claim 1, further comprising:
activating, by each UE of the plurality of UEs, use of the single frequency band for communication with the cellular network.

8. The method for using overlapping frequency bands of claim 1, wherein the single frequency band definition is transmitted as part of radio resource control (RRC) signaling from a central unit (CU) of the cellular network to the plurality of UEs.

9. The method for using overlapping frequency bands of claim 1, wherein the defined geographic region is a county.

10. The method for using overlapping frequency bands of claim 1, further comprising:
receiving, by the cellular network, a second set of priority data indicative that for the defined geographic region the cellular network is not the highest priority user;
determining, by the cellular network, based on the priority data, to cease using the first portion of the CBRS for communication with the plurality of UEs within the defined geographic region; and
in response to determining to cease using the first portion of the CBRS based on the priority data, transmitting a modified single frequency band definition to the plurality of UEs that deauthorizes use of the first portion of the CBRS and authorizes the second portion of the frequency band distinct from the CBRS.

11. A system for using overlapping frequency bands, the system comprising:
a cellular network that is in communication with a sensor network, wherein the cellular network comprises a plurality of base stations and a cellular network core, the cellular network being configured to:
receive priority data indicative that for a defined geographic region the cellular network is a highest priority user;
determine, based on the priority data, to use a first portion of the citizen band radio service (CBRS) for communication with a plurality of user equipments (UEs) within the defined geographic region;
determine, to use a second portion of a frequency band distinct from the CBRS for communication with the plurality of UEs; and
in response to (1) determining to use the first portion of the CBRS based on the priority data and (2) determining to use the second portion of the frequency band distinct from the CBRS, transmit a message activating a single frequency band definition at the plurality of UEs, wherein
the message causes use of the first portion of the CBRS and the second portion of the frequency band distinct from the CBRS.

12. The system for using overlapping frequency bands of claim 11, wherein the cellular network is further configured to communicate, via a base station of the plurality of base stations, with a UE of the plurality of UEs using the first portion of the CBRS and the second portion of the frequency band distinct from the CBRS.

13. The system for using overlapping frequency bands of claim 12, wherein communication with the UE is performed by the cellular network using a first maximum power level for the first portion of the CBRS and a second maximum power level for the second portion of the frequency band distinct from the CBRS, wherein the second maximum power level is greater than the first maximum power level.

14. The system for using overlapping frequency bands of claim 13, wherein the cellular network is a 5G New Radio (NR) cellular network and wireless communication with the UE is performed via a 5G NR cellular communication protocol.

15. The system for using overlapping frequency bands of claim 11, wherein the single frequency band definition indicates only the n78 frequency band.

16. The system for using overlapping frequency bands of claim 11, wherein the first portion of the CBRS and the second portion of the frequency band distinct from the CBRS define adjacent frequency blocks.

17. The system for using overlapping frequency bands of claim 11, further comprising the plurality of UEs, wherein each UE is configured to activate use of the single frequency band for communication with the cellular network.

18. The system for using overlapping frequency bands of claim 11, wherein the single frequency band definition is transmitted as part of radio resource control (RRC) signaling from a central unit (CU) of the cellular network to the plurality of UEs.

19. The system for using overlapping frequency bands of claim 11, wherein the defined geographic region is a county.

20. The system for using overlapping frequency bands of claim 11, wherein the cellular network is further configured to:
receive a second set of priority data indicative that for the defined geographic region the cellular network is not the highest priority user;
determine, based on the priority data, to cease using the first portion of the CBRS for communication with the plurality of UEs within the defined geographic region; and
in response to determining to cease using the first portion of the CBRS based on the priority data, transmit a second message indicative of a modified single frequency band definition to the plurality of UEs that deauthorizes use of the first portion of the CBRS.
